(19) United States
(12) Patent Application Publication
(10) Pub. No.: US 2010/0186542 A1
(43) Pub. Date: Jul. 29, 2010

(54) HANDLEBARS AND METHOD FOR PRODUCING SAME

(75) Inventor: Takahiko HASHIMOTO, Hamamatsu (JP)

Correspondence Address: BACON & THOMAS, PLLC, 625 SLATERS LANE, FOURTH FLOOR, ALEXANDRIA, VA, 22314-1176, US

(73) Assignee: KYOEI MANUFACTURING CO., LTD., Hamamatsu (JP)

(21) Appl. No.: 12/543,202

(22) Filed: Aug. 18, 2009

(30) Foreign Application Priority Data
Jan. 23, 2009 (JP) 2009-012804

(51) Int. Cl. B62K 21/12; B23P 17/00

(52) U.S. Cl. 74/551.1; 29/527.1

(57) ABSTRACT

A handlebar formed from a metal hollow pipe and having a generally uniform peripheral wall thickness along its entire length, including a longitudinal center portion, first and second end portions having a smaller outer diameter than that of the longitudinal center portion, and first and second, tapered intermediate portions connecting the center portion to the first and second end portions, respectively. The first and second, tapered intermediate portions and/or the first and second end portions are bent symmetrically with respect to the longitudinal center portion. The handlebar is produced by bending a hollow straight metal pipe, placing the resulting bent pipe between molds and feeding a pressurized liquid into the bent pipe while axially compressing the bent pipe to cause the peripheral wall of the bent pipe to plastically expand into conformity with a mold cavity defined by the molds.

### CROSS-REFERENCE TO RELATED APPLICATION

This application claims, under 35 USC 119, priority of Japanese Patent Application No. 2009-012804, filed Jan. 23, 2009 disclosure of which, inclusive of the specification, claims and drawings, is hereby incorporated by reference herein.

### BACKGROUND OF THE INVENTION

1. Field of the Invention

The present invention relates to a handlebar for a two-wheeled vehicle, a motorcycle in particular, and to a method for producing the handlebar,

2. Description of Prior Art

As related arts, U.S. Pat. No. 5,117,708 and No. 5,257,552 disclose a handlebar formed from a metal hollow pipe and having a longitudinal center section, and first and second bent sections each having a smaller diameter than the longitudinal center section and bent symmetrically with respect to the longitudinal center section, wherein the thickness of the sidewall of the longitudinal center section is smallest and the thickness of the sidewalls of the first and second bent sections is largest, or the thickness of the sidewall of the longitudinal center section is the largest and the thickness of the sidewalls of the first and second bent sections is the smallest.

Handlebars have hitherto been prepared by decreasing the diameter of both end sections of a straight metal pipe by swaging, and bending the reduced diameter end sections symmetrically with respect to the longitudinal center section thereof using a bending machine.

Since the handlebars thus produced have a sidewall with non-uniform thickness along the length thereof, the large wall-thickness portions may contain more material than necessary and have greater strength than necessary. Also, according to the above method, it is difficult to produce a handlebar whose both end sections are consistent in mass and strength. In addition, bending the swaged end sections may result in low bending accuracy and non-uniformity in the bending angle because of occurrence of spring back or the operating error of the bending machine. Furthermore, the bent parts are unlikely to become perfectly circular in cross-section and therefore tend to be inconsistent in strength.

### SUMMARY OF THE INVENTION

It is, therefore, the primary object of the present invention to provide a handlebar with consistent strength throughout its length in all directions, high profile accuracy and excellent appearance.

Another object of the present invention is to provide a method for producing a handlebar with uniform wall thickness high profile accuracy and consistent strength.

In accordance with one aspect of the present invention, there is provided a handlebar of a metal hollow pipe including, a longitudinal center portion having opposite first and second ends, first and second intermediate portions extending outwardly from the first and second ends, respectively, each of the first and second intermediate portions being tapered outwardly and having a distal end, and first and second end portions extending outwardly from the distal ends of the first and second intermediate portions, respectively, and each having a smaller outer diameter than that of the longitudinal center portion, wherein the longitudinal center portion, the first and second intermediate portions and the first and second end portions have substantially the same peripheral wall thickness. The first and second intermediate portions and/or the first and second end portions are bent such that the first and second intermediate portions are symmetrical to each other with respect to the longitudinal center portion and the first and second end portions are symmetrical to each other with respect to the longitudinal center portion.

According to the first aspect of the present invention, there can be provided a handlebar that does not have portions having excessive peripheral wall thickness and that has lateral portions with generally the same strength and weight as other portions.

In a second aspect, the present invention provides a method for producing a handlebar, including the steps of:

providing a hollow straight metal pipe having a longitudinal center portion, first and second end portions, and first and second intermediate portions positioned between the longitudinal center portion and the first and second end portions, said hollow straight metal pipe having a generally uniform outer diameter and a generally uniform peripheral wall thickness;

bending the first and second intermediate portions and/or the first and second end portions to obtain a bent pipe in which the first and second intermediate portions are symmetrical to each other with respect to the longitudinal center portion and the first and second end portions are symmetrical to each other with respect to the longitudinal center portion;

providing a pair of separable molds relatively movable between an open position and a closed position and configured to define a mold cavity in the closed position which can receive the bent pipe, the said mold cavity comprising a longitudinal center section having a diameter greater than the outer diameter of the hollow straight metal pipe, first and second end sections having a diameter generally equal to the outer diameter of the hollow straight metal pipe, and first and second intermediate sections contiguously extending between the longitudinal center section and the first and second end section and tapered outwardly from the diameter of the longitudinal center section to the diameter of the first and second end sections, respectively;

closing the molds with the bent pipe being positioned between the molds; and

feeding a pressurized liquid into the bent pipe while axially compressing the bent pipe to plastically deform the peripheral wall of the bent pipe into conformity with the mold cavity to produce the handlebar having a generally uniform peripheral wall thickness along the entire length thereof.

According to the method of the present invention, the handlebar having a generally uniform peripheral wall thickness along its entire length can be obtained. Namely, since the expansion of the center region is carried out while axially compressing the bent pipe from both ends, the material for the expansion of the longitudinal center portion and the intermediate portions is provided from the end portions. Further, since hydroforming, explained later, is performed after bending of the pipe, the bending accuracy of the intermediate and/or end portions and the circularity of the bent parts can be improved. As a result, a handlebar having consistent strength, high profile accuracy and excellent appearance can be provided.

### BRIEF DESCRIPTION OF THE DRAWINGS

Other objects, features and advantages of the present invention will become apparent from the detailed description of the preferred embodiments of the invention, which follows, when considered in the light of the accompanying drawings, in which:

FIG. 1 is a front view of a handlebar of a first embodiment of the present invention;

FIG. 2 is an enlarged cross-sectional view taken along the line II-II of FIG. 1;

FIG. 3 is an enlarged cross-sectional view taken along the line III-III of FIG. 1;

FIG. 4 is an enlarged cross-sectional view taken along the line IV-IV of FIG. 1;

FIG. 5 is a plan view of a handlebar of a second embodiment of the present invention;

FIG. 6 is an enlarged cross-sectional view taken along the line VI-VI of FIG. 5;

FIG. 7 is an enlarged cross-sectional view taken along the line VII-VII of FIG. 5;

FIG. 8 is a side view of a raw material hollow pipe;

FIG. 9 is an enlarged cross-sectional view taken along the line IX-IX of FIG. 8;

FIG. 10 is a partial front view illustrating the manner in which a hollow pipe is bent with a bending machine;

FIG. 11 is a side view of a bent pipe;

FIG. 12 is an enlarged cross-sectional view taken along the line XII-XII of FIG. 11;

FIG. 13 is a cross-sectional view illustrating a state in which a bent pipe is placed between separable molds; and

FIG. 14 is a partial enlarged cross-sectional view illustrating the manner in which a handlebar of the present invention is shaped.

### DETAILED DESCRIPTION OF THE PREFERRED EMBODIMENTS OF THE INVENTION

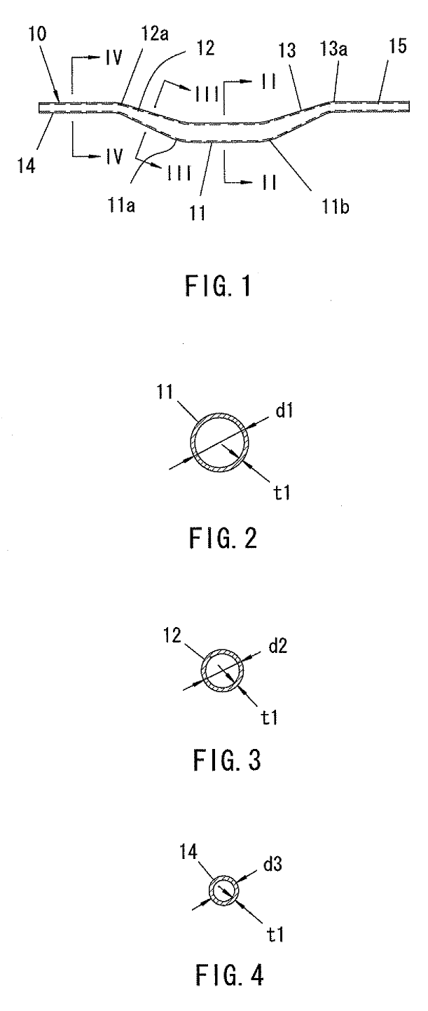

Referring now to FIG. 1 to FIG. 4, designated as 10 is a handlebar according to a first embodiment of the present invention. In the first embodiment, the handlebar 10 is formed from an aluminum alloy hollow pipe. The handlebar 10 has a longitudinal center portion 11 having first and second ends 11a and 11b; first and second intermediate portions 12 and 13 contiguously extending outwardly from the first and second ends 11a and 11b, respectively, of the longitudinal center portion 11 and having distal ends 12a and 13a, respectively; and first and second end portions 14 and 15 contiguously extending outwardly from the distal ends 12a and 13a, respectively, of the first and second intermediate portions 12 and 13. The longitudinal center portion 11 has a circular cross-section with a large outer diameter (d1). The first and second end portions 14 and 15 have the shape of a straight tube and have a circular cross-section with a smaller outer diameter (d3). The first and second intermediate portions 12 and 13 has a circular cross-section, and are tapered outwardly and merge with the first and second end portions 14 and 15, respectively.

The handlebar 10 has a substantially uniform peripheral wall thickness (t1) along its entire length. Namely, the longitudinal center portion 11, the first and second intermediate portions 12 and 13 and the first and second end portions 14 and 15 have substantially the same peripheral wall thickness. As used herein, the term “substantially the same peripheral wall thickness” is intended to mean that the difference between the largest peripheral wall thickness and the smallest peripheral wall thickness measured over the entire length of the handlebar 10 is not greater than 0.6 mm. Such a difference is preferably not greater than 0.4 mm, more preferably not greater than 0.2 mm.

The first and second intermediate portions 12 and 13 are bent obliquely upwardly in a first plane at an angle of generally 22° to 70° and are symmetrical to each other with respect to the longitudinal center portion 11. The first and second end portions 14 and 15 are bent in a second plane at an angle of generally 7° to 80° and are symmetrical to each other with respect to the longitudinal center portion 11. The first and second end portions 14 and 15 may extend generally in parallel to the longitudinal center portion 11 as viewed from the front, though this is not essential. The first and second planes may be coincident with each other or different from each other with an angle between the first and second planes being generally 10° to 25°. The tapered configuration of the handlebar 10 of the present invention may be similar to that shown in FIGS. 3-5 of U.S. Pat. No. 5,117,708 disclosure of which, inclusive of the specification and drawings, is hereby incorporated by reference herein.

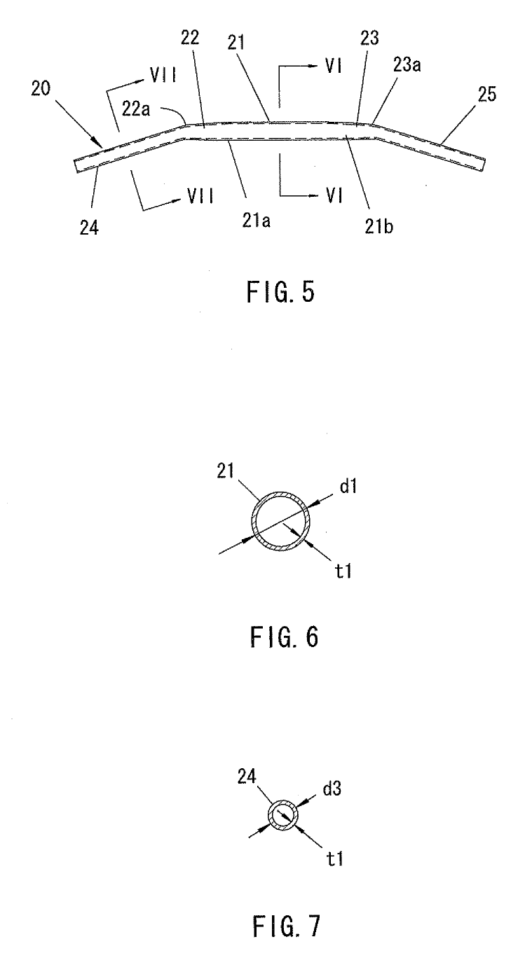

Referring next to FIG. 5 to FIG. 7, designated as 20 is a handlebar according to a second embodiment of the present invention. The handlebar 20 is formed from an aluminum alloy hollow pipe as in the case of the handlebar 10 of the first embodiment. The handlebar 20 has a generally uniform peripheral wall thickness (t1) along its entire length.

The handlebar 20 has a longitudinal center portion 21 having first and second ends 21a and 21b; first and second intermediate portions 22 and 23 contiguously extending outwardly from the first and second ends 21a and 21b, respectively, of the longitudinal center portion 21 and having distal ends 22a and 23a, respectively; and first and second end portions 24 and 25 contiguously extending outwardly from the distal ends 22a and 23a, respectively of the first and second intermediate portions 22 and 23. The longitudinal center portion 21 has a circular cross-section with a large outer diameter (d1) as in the case of the handlebar 10 of the first embodiment. The first and second intermediate portions 22 and 23 has a circular cross-section, and are tapered outwardly and merge with the first and second end portions 24 and 25, respectively. The first and second intermediate portions 22 and 23 extend substantially coaxially with the longitudinal center portion 21. The first and second end portions 24 and 25 have a smaller outer diameter (d3) as in the case of the end portions 14 and 15 described before, and are bent backward in a plane at an angle of generally 22° to 70° and are symmetrical to each other with respect to the longitudinal center portion 21.

In the above embodiments, the outer diameter d1 of the longitudinal center portions 11 and 21 is generally in the range of 25 to 35 mm, preferably 27 to 30 mm, most preferably 28 to 29 mm. The outer diameter d3 of the end portions 14, 15, 24, 25 is generally in the range of 20 to 25 mm, preferably 21 to 24 mm, most preferably 22 to 23 mm. The outer diameter ratio d1/d3 is generally in the range of 1.2 to 1.4. The thickness t1 is generally in the range of 1.5 to 5 mm, preferably 3 to 4 mm.

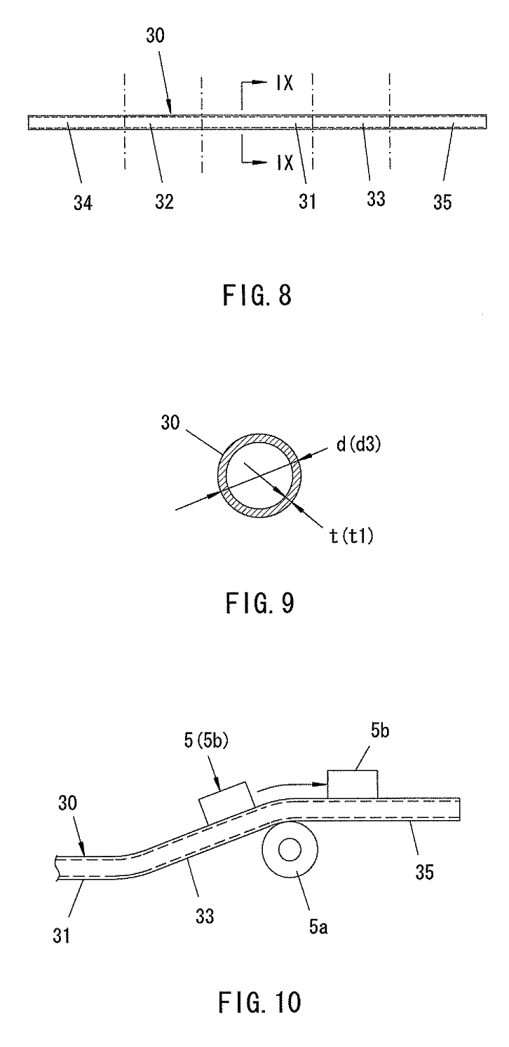

A method for producing the handlebar 10 of the first embodiment is described as an example of the method for producing a handlebar of the present invention. As shown in FIG. 8 and FIG. 9, a hollow pipe 30 having a longitudinal center portion 31, first and second intermediate portions 32 and 33, and first and second end portions 34 and 35 is used as a raw material pipe. The pipe 30, which may be made of, for example, a 7000-series aluminum alloy (such as 7NO1 aluminum alloy), is a straight pipe having, along its entire length, a peripheral wall thickness (t) which generally corresponds to the peripheral wall thickness (t1) of the handlebar 10 as a final product and an outer diameter (d) which generally corresponds to the outer diameter (d3) of the end portions 14 and 15 of the handlebar 10. The hollow pipe 30 has a length sufficient to form the handlebar 10.

The hollow pipe 30 is processed as follows. First, the intermediate portions 32 and 33 and the end portions 34 and 35 of the hollow pipe 30 are bent symmetrically with respect to the longitudinal center portion 31 using a bending machine 5. That is, as shown in FIG. 10, the hollow pipe 30 is placed in the bending machine 5 having a bending roll 5a and a pressing slider 5b such that the bending roll 5a and the pressing slider 5b abut against the inside and outside, respectively, of a part of the hollow pipe 30 at which the hollow pipe 30 is to be bent. The pressing slider 5b is then moved a predetermined distance around the bending roll 5a with a part of the hollow pipe 30 close to the center thereof firmly supported until the hollow pipe 30 is bent at a desired angle.

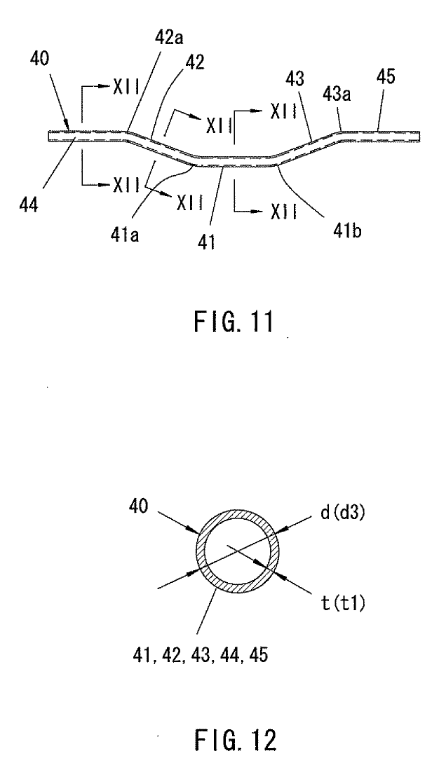

According to the above procedure, the intermediate portions 32 and 33 are bent upward in a first plane and symmetrically with respect to the longitudinal center portion 31 and the end portions 34 and 35 are bent in a second plane until they are parallel to the longitudinal center portion 31 as viewed from the front. As a result, a bent pipe 40 having a longitudinal center portion 41 having a first and second ends 41a and 41b; first and second intermediate portions 42 and 43 extending symmetrically and obliquely upward from the first and second ends 41a and 41b, respectively, of the longitudinal center portion 41 at the same angle relative thereto and having distal ends 42a and 43a, respectively; and first and second end portions 44 and 45 extending symmetrically from the distal ends 42a and 43a, respectively, of the first and second intermediate portions 42 and 43 at the same angle relative thereto and generally parallel to the longitudinal center portion 41 as viewed from the front, and having an outer diameter (d) and a peripheral wall thickness (t) which are substantially the same as those of the hollow pipe 30 along its entire length as shown in FIG. 11 and FIG. 12 is obtained.

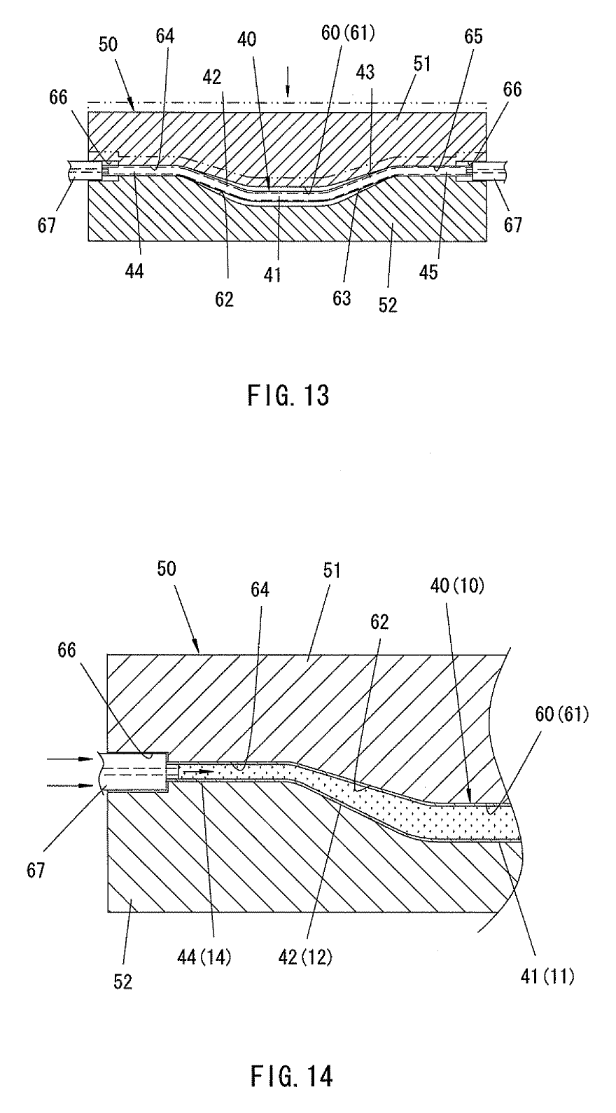

Then, as shown in FIG. 13, the bent pipe 41 is placed between separable upper and lower molds 51 and 52 of a molding machine 50. Each of the upper and lower molds 51 and 52 of the molding machine 50 has a shaping recess in its mating surface. When the upper and lower molds 51 and 52 are mated with each other, the shaping recesses of the upper and lower molds 51 and 52 define a mold cavity 60 having an internal shape corresponding to the external shape of the handlebar 10 as a final product. Thus, the mold cavity 60 has a longitudinal center section 61 having a diameter generally corresponding to the outer diameter (d1) of the longitudinal center portion 11 of the handlebar 10 (final product), e.g., about 29 mm, first and second intermediate sections 62 and 63 having a tapered shape generally corresponding to the shape of the intermediate portions 12 and 13 of the handlebar 10 (final product), and first and second end sections 64 and 65 having an outer diameter generally equal to the outer diameter of the first and second end portions 14 and 15 of the handlebar 10 (final product), e.g., about 22 mm. Designated as 66 are guides into which pressurizing nozzles 67, which are described later, are fittable.

The lower mold 52 of the molding machine 50 is a stationary mold fixed to a base, and the upper mold 51 is a movable mold which is movable up and down relative to the stationary mold 52 by a hydraulic cylinder between an open position and a closed position. After the bent pipe 40 has been placed in the shaping recess of the stationary mold 52, the movable mold 51 is moved into mating contact with the stationary mold 52 (from the open position shown by phantom lines to the closed position shown by solid lines in FIG. 13), whereby the first and second end portions 44 and 45 of the bent pipe 41 are surrounded by and in close contact with the first and second end sections 64 and 65, respectively, of the mold cavity 60, and the longitudinal center portion 41 and the first and second intermediate portions 42 and 43 of the bent pipe 40 are surrounded by the longitudinal center section 61 and the first and second intermediate sections 62 and 63, respectively, of the mold cavity 60 with given gaps therebetween.

Next, the pressurizing nozzles 67 are fitted into the guides 66 of the first and second end sections 64 and 65 of the mold cavity 60, and a pressurized liquid (such as water or oil) is fed into the bent pipe 40 through the holes extending along the center axes of the pressurizing nozzles 67 while axially compressing the bent pipe 40 with the pressurizing nozzles 67 to cause the peripheral wall of the bent pipe 40 to plastically deform (expand radially outwardly) into conformity with the internal surface of the mold cavity 60 as shown in FIG. 14. The axially compressing force is generally 10 tons to 20 tons.

As a result, the handlebar 10 (final product) as shown FIG. 1, can be obtained. Since the handlebar 10 is formed by feeding a pressurized liquid into the bent pipe 40 to cause the peripheral wall thereof to expand into conformity with the internal surface of the mold cavity 60, the bent parts between the longitudinal center portion 11 and the first and second intermediate portions 12 and 13 and the bent parts between the intermediate portions 12 and 13 and the first and second end portions 14 and 15 may be perfectly circular in cross-section. Moreover, since the bent pipe 40 is axially compressed from both ends and since the material for the expansion of the longitudinal center portion 11 and the first and second intermediate portions 12 and 13 is supplied from the first and second end portions 14 and 15, the peripheral wall thickness of the longitudinal center portion 11 and the intermediate portions 12 and 13 is not decreased. In this case, the amount of compression in the axial direction is preferably 15% to 20% of the length of the bent pipe 40. The processing of the bent pipe 40 using the molding machine 50 is carried out under general hydroforming conditions using a pressurized liquid having a pressure of generally about 50 MPa to 200 MPa and a temperature of generally 40 to 90° C. The pressure of the liquid may vary depending upon the material of the pipe and intended dimension of the handlebar. The handlebar of the present invention may be made of iron, a magnesium alloy, an aluminum alloy or any other customarily employed metal.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description, and all the changes which come within the meaning and range of equivalency of the claims are therefore intended to be embraced therein.

What is claimed is:

1. A handlebar of a metal hollow pipe, comprising:
a longitudinal center portion having opposite first and second ends;
first and second intermediate portions extending outwardly from the first and second ends, respectively, each of the first and second intermediate portions being tapered outwardly and having a distal end; and
first and second end portions extending outwardly from the distal ends of the first and second intermediate portions, respectively, and each having a smaller outer diameter than that of the longitudinal center portion,
wherein the longitudinal center portion, the first and second intermediate portions and the first and second end portions have substantially the same peripheral wall thickness; and
wherein the first and second intermediate portions and/or the first and second end portions are bent such that the first and second intermediate portions are symmetrical to each other with respect to the longitudinal center portion and the first and second end portions are symmetrical to each other with respect to the longitudinal center portion.

2. A handlebar according to claim 1, wherein the first and second intermediate portions are bent in a first plane and symmetrically to each other with respect to the longitudinal center portion, and wherein the first and second end portions are bent in a second plane and symmetrically to each other with respect to the longitudinal center portion.

3. A handlebar according to claim 2, wherein the first and second planes are coincident with each other.

4. A handlebar according to claim 2, wherein the first and second planes are different from each other.

5. A handlebar according to claim 1, wherein the first and second intermediate portions are bent in a plane and symmetrically to each other with respect to the longitudinal center portion, and wherein the first and second end portions extend substantially coaxially with the first and second intermediate portions, respectively.

6. A handlebar according to claim 1, wherein the first and second intermediate portions extend substantially coaxially with the longitudinal center portion, and wherein the first and second end portions are bent in a plane and symmetrically to each other with respect to the longitudinal center portion.

7. A handlebar according to claim 1, obtained from a single hollow straight metal pipe with a generally uniform outer diameter and a generally uniform peripheral wall thickness.

8. A method for producing a handlebar, comprising the steps of:
providing a hollow straight metal pipe having a longitudinal center portion, first and second end portions, and first and second intermediate portions positioned between the longitudinal center portion and the first and second end portions, said hollow straight metal pipe having a generally uniform outer diameter and a generally uniform peripheral wall thickness;
bending the first and second intermediate portions and/or the first and second end portions to obtain a bent pipe in which the first and second intermediate portions are symmetrical to each other with respect to the longitudinal center portion and the first and second end portions are symmetrical to each other with respect to the longitudinal center portion;
providing a pair of separable molds relatively movable between an open position and a closed position and configured to define a mold cavity in the closed position which can receive the bent pipe, said mold cavity comprising a longitudinal center section having a diameter greater than the outer diameter of the hollow straight metal pipe, first and second end sections having a diameter generally equal to the outer diameter of the hollow straight metal pipe, and first and second intermediate sections contiguously extending between the longitudinal center section and the first and second end section and tapered outwardly from the diameter of the longitudinal center section to the diameter of the first and second end sections, respectively;
closing the molds with the bent pipe being positioned between the molds; and
feeding a pressurized liquid into the bent pipe while axially compressing the bent pipe to plastically deform the peripheral wall of the bent pipe into conformity with the mold cavity to produce the handlebar having a generally uniform peripheral wall thickness along the entire length thereof.

9. A method according to claim 8, wherein the first and second intermediate portions are bent in a first plane and symmetrically to each other with respect to the longitudinal center portion, and the first and second end portions are bent in a second plane and symmetrically to each other with respect to the longitudinal center portion.

10. A method according to claim 9, wherein the first and second planes are coincident with each other.

11. A method according to claim 9, wherein the first and second planes are different from each other.

12. A method according to claim 8, wherein the first and second intermediate portions are bent in a plane and symmetrically to each other with respect to the longitudinal center portion, while maintaining the first and second end portions in substantially coaxial with the first and second intermediate portions, respectively.

13. A method according to claim 1, wherein the first and second end portions are bent in a plane and symmetrically to each other with respect to the longitudinal center portion while maintaining the first and second intermediate portions in substantially coaxial with the longitudinal center portion.
